(19) United States
(12) Patent Application Publication
(10) Pub. No.: US 2024/0394578 A1
(43) Pub. Date: Nov. 28, 2024

(54) ORCHESTRATION FOR IDENTIFYING A QUANTUM ANNEALER TO SOLVE COMBINATORIAL OPTIMIZATION PROBLEMS

(71) Applicant: Dell Products L.P., Round Rock, TX (US)

(72) Inventors: Ítalo Gomes Santana, Rio de Janeiro (BR); Diego Vrague Noble, Pelotas (BR); Miguel Paredes Quiñones, Campinas (BR)

(21) Appl. No.: 18/321,311

(22) Filed: May 22, 2023

(51) Int. Cl. G06N 10/20; G06N 10/80

(52) U.S. Cl. CPC G06N 10/20; G06N 10/80

(57) ABSTRACT

Selecting a quantum annealer for executing a quantum job is disclosed. A classifier is trained using data associated with combinatorial optimization problems that have been solved and quantum annealers used to solve the combinatorial optimization problems. After training, the classifier may receive a new or test problem as input and output an ordered list of labels. Each of the labels corresponds to a quantum annealer. The problem being evaluated can be directed to a most relevant quantum annealer identified in the list. If the problem cannot be solved, the process iterates through the other quantum annealers identified in the list of labels.

### FIELD OF THE INVENTION

Embodiments of the present invention generally relate to quantum computing systems and to orchestrating quantum jobs. More particularly, at least some embodiments of the invention relate to systems, hardware, software, computer-readable media, and methods for identifying a quantum computing system for solving a combinatorial optimization problem.

### BACKGROUND

Combinatorial optimization problems (COPs) are examples of computationally solvable problems. However, there is no known algorithm for finding the best solution in a reasonable amount of time. Much research has been devoted to finding classical heuristic techniques that seek good enough solutions to these problems.

A potential solution to this problem is to employ quantum annealing technologies to solve combinatorial optimization problems. While promising, these quantum annealing technologies are often restricted. These restrictions manifest themselves in the number of available qubits, memory throughput, integer representation, and embedding technologies.

From a customer perspective, the decision regarding the best quantum annealing system has the potential to exacerbate the time and cost required for an entity to adopt quantum annealing technologies. In other words, it is difficult for a customer to select the best quantum annealing technology for a particular problem. Further, there are various legal issues related to the paid use of quantum annealing technologies that prevent potential users from exploring and investigating these technologies and their ability to solve combinatorial optimization problems.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses example aspects of executing quantum jobs generally;

FIG. 2 discloses aspects of selecting a quantum computing system for executing a quantum job;

FIG. 3 discloses aspects of training a classification machine learning model configured to generate an ordered output list of relevant quantum computing systems for executing a quantum job;

FIG. 4 discloses aspects of performing a quantum job using the output of the classification machine learning model;

FIG. 5A discloses additional aspects of training a classification machine learning model;

FIG. 5B discloses further aspects of training a classification machine learning model;

FIG. 6 discloses aspects of a modular orchestration service configured to select a quantum computing system based on multiple objectives;

FIG. 7 discloses aspects of a method for selecting a quantum annealing system in an automatic and informed manner; and

FIG. 8 discloses aspects of a computing device, system, or entity.

### DETAILED DESCRIPTION OF SOME EXAMPLE EMBODIMENTS

Embodiments of the present invention generally relate to quantum computing systems and solving combinational optimization problems (COPs). More particularly, at least some embodiments of the invention relate to systems, hardware, software, computer-readable media, and methods for identifying a quantum computing system to solve combinatorial optimization problems.

While combinatorial optimization problems are computationally solvable, substantial time is required to generate a solution. Various heuristic techniques may be used to find a solution that is sufficient even if not necessarily the best solution. Quantum annealing systems are examples of quantum computing systems that are configured to solve combinatorial optimization problems. Quantum annealing systems, which may be simulated or real, are typically constructed to solve combinatorial optimization problems efficiently and robustly.

However, quantum annealing systems cannot solve a combinatorial optimization problem directly. When a combinatorial optimization problem is presented, the combinatorial optimization problem must be converted to a Binary Quadratic Model (BQM). Examples of BQMs include Quadratic Unconstrained Binary Optimization (QUBO) and Ising models. Even if a combinatorial optimization problem can be converted to an appropriate form, solving the BQM may not be feasible on a particular quantum annealing system for various reasons such as qubit connectivity, qubit availability, resource unavailability, or the like. Problems with similar settings (e.g., constraints and objective function) on different scales may not perform well in the very same quantum annealing system due to hardware limitations and COP requirements (e.g., integer encoding).

Embodiments of the invention relate to an orchestration service that is configured to automate the process of selecting a quantum annealing system for executing a BQM such as a QUBO configuration. The orchestration service receives a combinatorial optimization problem (or an encoded problem such as a QUBO configuration) as input and outputs an ordered list of quantum annealing systems that is sorted by their compatibility or relevance to solve the input combinatorial optimization problem. Thus, the first entry in the list is likely the most relevant quantum annealing system and the last entry in the list is likely the least relevant quantum annealing system. Selecting the first entry to solve the combinatorial optimization problem is likely to be more efficient (at least in terms of execution time) compared to solving the combinatorial optimization problem with the last entry in the output list.

Embodiments of the invention use previously encoded combinatorial optimization problems and telemetry data as a training set to train a classification machine learning model (a classifier). Issues such as false positives from the classifier or infrastructural obstacles (e.g., hardware limitations) that prevent the combinatorial optimization problem from being solved in a selected quantum annealing system can be circumvented by selecting the next quantum annealing system in the list output by the classifier in an iterative fashion. In one example, an empty list would indicate that no quantum annealing system effectively solves the problem. Embodiments of the invention thus allow various quantum annealing systems, which may be associated with different providers, to be automatically assessed and recommended based, by way of example, on their relevance to the problem to be solved. The orchestration service, which includes a classifier, can generate a list of quantum annealing systems that are sorted by their relevance to the problem being solved. The classifier may be trained to select the quantum annealing system that solved a similar combinatorial optimization problem efficiently.

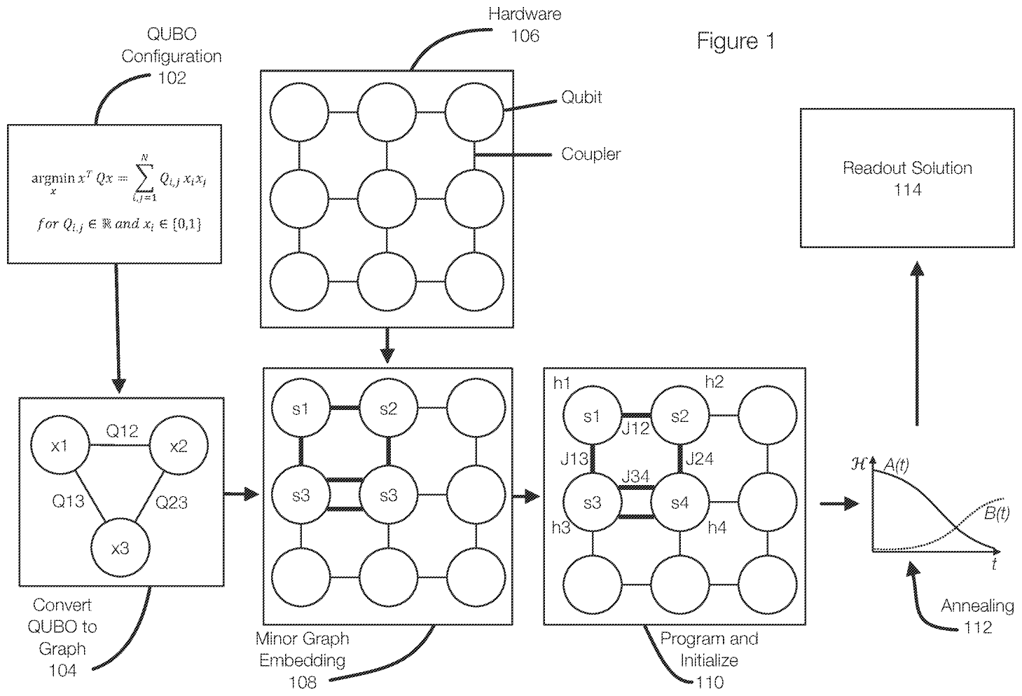

FIG. 1 generally illustrates an example of a quantum job workflow. The quantum job workflow extends, by way of example, from receiving a combinatorial optimization problem to generating a solution at a quantum computing system.

When a combinatorial optimization problem is received, the combinatorial optimization problem is typically processed or encoded in order to generate a BQM configuration, such as a QUBO definition 102. The QUBO definition 102 is converted into a graph 104. Next, a minor embedding operation 108 is performed to map the QUBO graph 104 to the hardware 106 of a quantum computing system, such as a quantum annealer (or quantum annealing system). Mapping the graph to the hardware is an example of a minor embedding operation that may not be possible on a given quantum annealer.

Once the minor graph embedding 108 is completed and a quantum annealing system is selected, the quantum annealing system may be programmed and initialized 110 and the quantum job is executed by performing an annealing process 112. The solution 114 may then be read out or determined when the annealing process 112 is completed. In some examples the solution may be resampled and the annealing process may be repeated. Aspects of quantum annealing are further described in Quantum Annealing for Industry Applications: Introduction and Review, Sheir Yarkoni et al 2022 Rep. Prog. Phys. 85 104001, which is incorporated by reference in its entirety.

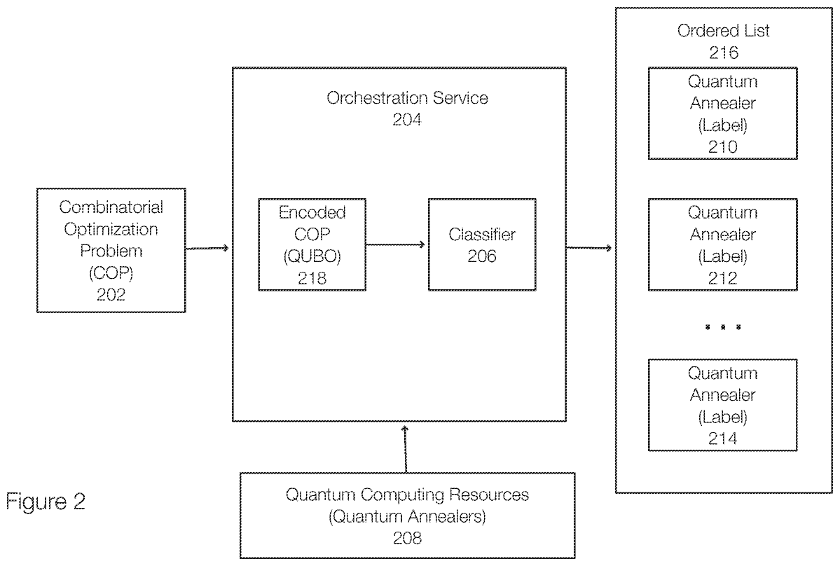

FIG. 2 discloses aspects of an orchestration service configured to identify one or more quantum annealing systems to execute a quantum job to solve a combinatorial optimization problem. In FIG. 2, a combinatorial optimization problem 202 is received at the orchestration service 204. In FIG. 2, the combinatorial optimization problem 202 may be encoded (e.g., transformed into a QUBO configuration).

The encoded combinatorial optimization problem 218 or QUBO configuration may be an example of data that is input to the classifier 206. The classifier 206 is configured to predict or output a list of labels, such as the ordered list 216, for the combinatorial optimization problem 202. Each of the labels in the ordered list 216 corresponds to a quantum annealing system in this example. Alternatively, the classifier 206 could be configured to output other data such as quantum annealing system identifiers. The ordered list 216 references the quantum annealers associated with the labels directly. The quantum annealing systems included in the list 216 are represented by quantum annealers 210, 212, and 214. The quantum annealers 210, 212, and 214 may be selected from a pool of quantum computing resources 208.

In one example, the list 216 may include all possible quantum annealers. Alternatively, the list 216 may include a subset of the quantum computing resources 208. The list 216 is ordered, in one example, by relevance to the input combinatorial optimization problem 202. In this example, the quantum annealer 210 is thus the most highly recommended or most relevant quantum annealer identified by the classifier 206.

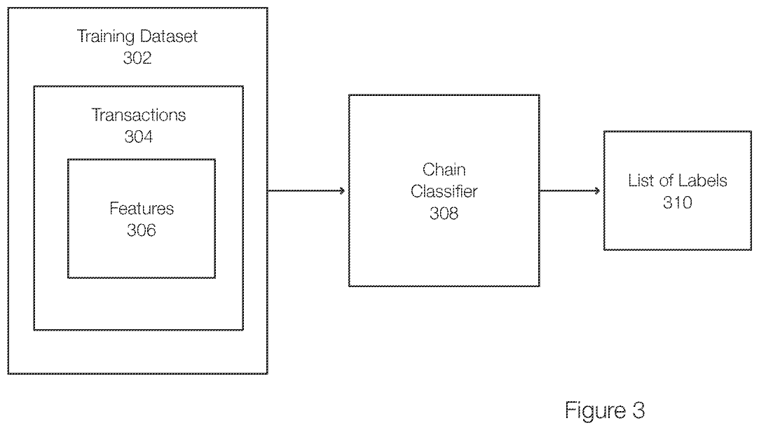

FIG. 3 discloses aspects of training a classifier. FIG. 3 illustrates, more specifically, aspects of training a classification machine learning model such as the classifier 206 shown in FIG. 2. In one example and as illustrated in FIG. 3, a chain classifier 308 may be trained with a training dataset 302 to generate a list of labels 310. Each of the labels corresponds to a quantum annealing system in one example as previously described.

The training dataset 302 may include transactions 304 for each of multiple previously solved combinatorial optimization problems. The transactions 304 may each include features associated with the combinatorial optimization problems, the annealer used to solve the combinatorial optimization problem, or the like. Each of the transactions 304 may include features extracted from a combinatorial optimization problem setting along with features of the annealer used to solve the combinatorial optimization problem. Each of the transactions may include a label, this identifies the quantum annealing system used to solve the combinatorial optimization problem.

For example, telemetry data of the quantum annealing system may be included in the features 306. This may include, for a given combinatorial optimization problem or transaction, computational time, number of required qubits, the topology of the quantum annealer, or the like. The features 306 may also include or represent aspects of the combinatorial optimization problem such as number of edges/nodes in the graph, sparsity level, node degree, node positioning, or the like.

Once the training dataset 302 is generated from the previously solved combinatorial optimization problems and telemetry data, the training dataset 302 may be used to train the chain classifier 308 to output a list of labels 310. The chain classifier 308 is configured to generate predictions or outputs sequentially in one example. These outputs can be assembled into the list of labels 310. Thus, the chain classifier 308 generates output iteratively and each output becomes an input for the next iteration. In this manner, the chain classifier 308 can generate a list of labels 310 that includes ordered labels. The initial or first entry in the ordered list is the best label (or most relevant quantum annealing system). The second entry in the list of labels 310 is the second most relevant quantum annealing system for the combinatorial optimization problem being evaluated. The chain classifier 308 may operate until a predetermined number of entries or labels are included in the list of labels 310 or until all available labels have been used or output by the classifier 308. In another example, the classifier may be configured as a probabilistic model that is configured to return a sequence of labels sorted by relevance according to the input.

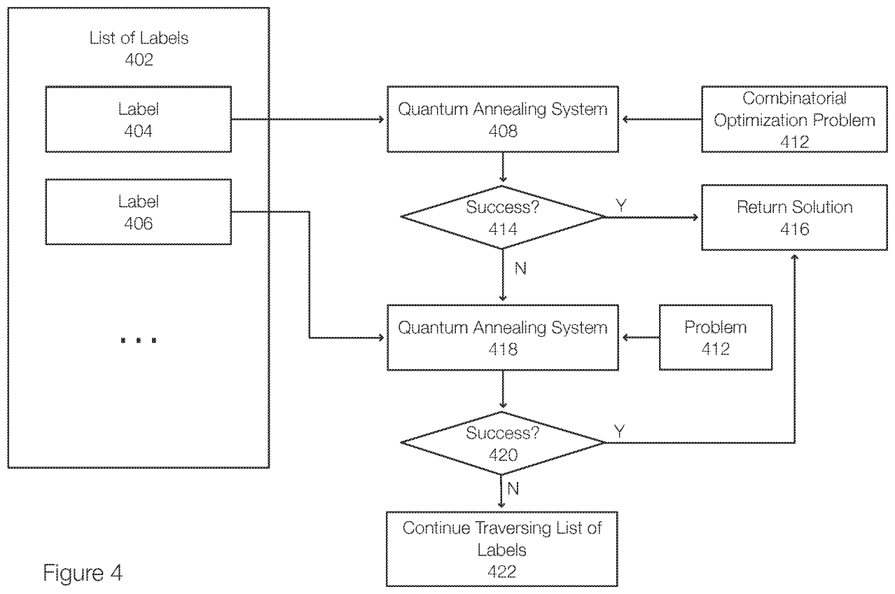

FIG. 4 discloses aspects of performing a quantum job using the output of a trained classifier. FIG. 4 illustrates an ordered list of labels 402, represented by the labels 404 and 406, that was output by a classifier according to an input combinatorial optimization problem. Each of the labels 404 and 406 correspond to or identify a quantum annealing system. The list of labels 402 identifies, in effect, the quantum annealing systems in a sorted order starting with the best or most relevant quantum annealing system. In other words, the classifier indicates that the first label corresponds to the most relevant quantum annealing system for the current combinatorial optimization problem. The next label is the next most relevant quantum annealing system for the input combinatorial optimization problem.

In this example, the label 404 corresponds to the quantum annealing system 408. During execution, the combinatorial optimization problem 412, after conversion to a QUBO or other configuration, is input to the quantum annealing system 408 because the quantum annealing system 408 is the most relevant quantum annealing system based on the list of labels 402. Stated differently, the orchestration service may initially deploy the problem 412 to the quantum annealing system 408 because the quantum annealing system 408 is deemed the most relevant quantum annealing system for the problem 412 by the classifier.

If the problem 412 can be solved by the quantum annealing system 408 (Y at 414), then a solution is returned 416. If the problem 412 cannot be solved by the quantum annealing system 408 (N at 414), the problem 412 is input to the next most relevant quantum annealing system, which is the quantum annealing system 418 in this example, which corresponds to the next label 406 in the list of labels 402.

If the problem 412 is solved by the quantum annealing system 418 (Y at 420), the solution is returned 416. If the problem 412 is not solved by the quantum annealing system 418 (N at 420), embodiments of the invention continue traversing 422 the list of labels in the list of labels 402 in the sorted order.

A quantum annealing system may not be able to solve the problem 412 (e.g., N at 414 or N at 420) for various reasons such as a false positive output by the classifier, hardware limitations, the quantum annealing system is currently being used, or the like.

Embodiments of the invention thus allow a quantum annealing system to be selected in an automatic and informed manner, thereby avoiding arbitrary selections and potentially poor performance/efficiency. In a worst-case scenario, the problem 412 cannot be solved and the user or customer is informed. If the failure is due to a quantum annealing system being unavailable, the orchestration service may attempt to execute the quantum job at a later time.

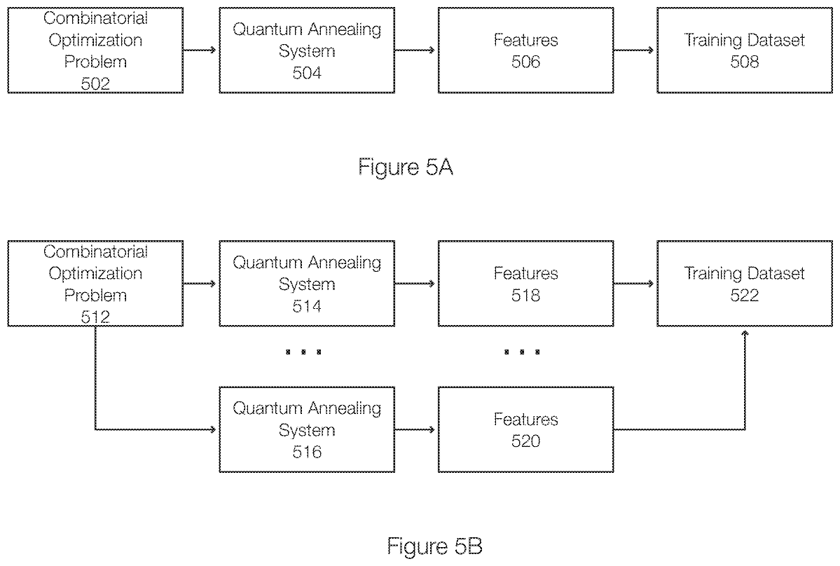

FIG. 5A discloses aspects of training a classifier. In FIG. 5A, a combinatorial optimization problem 502 may be, after conversion to an appropriate format such as a QUBO configuration, provided to a quantum annealing system 504 identified in the list of labels. When execution is successful and the combinatorial optimization problem 502 is solved by the selected quantum annealing system, features 506 (e.g., memory consumption, CPU usage, execution time, other telemetry data, number of edges in graph, number of nodes, sparsity level, node degree, node positioning, or the like) are extracted/identified and added to the training dataset 508. The updated or augmented training dataset can be used to train or retrain the classifier.

FIG. 5B discloses additional aspects of training a classifier. In FIG. 5B, the combinatorial optimization problem 512 is executed at multiple quantum annealing systems, represented by quantum annealing systems 514 and 516. Features 518 and 520 from each of these executions are extracted/added to the training dataset 522, an example of the training datasets 508 and 302. The prediction quality of the classifier can be improved when some of the combinatorial optimization problems from or associated with the training dataset 522 are executed on different quantum annealing systems. This allows the features extracted from the execution or the problem or quantum system to reflect different executions and/or represent the execution more accurately across multiple quantum annealing systems.

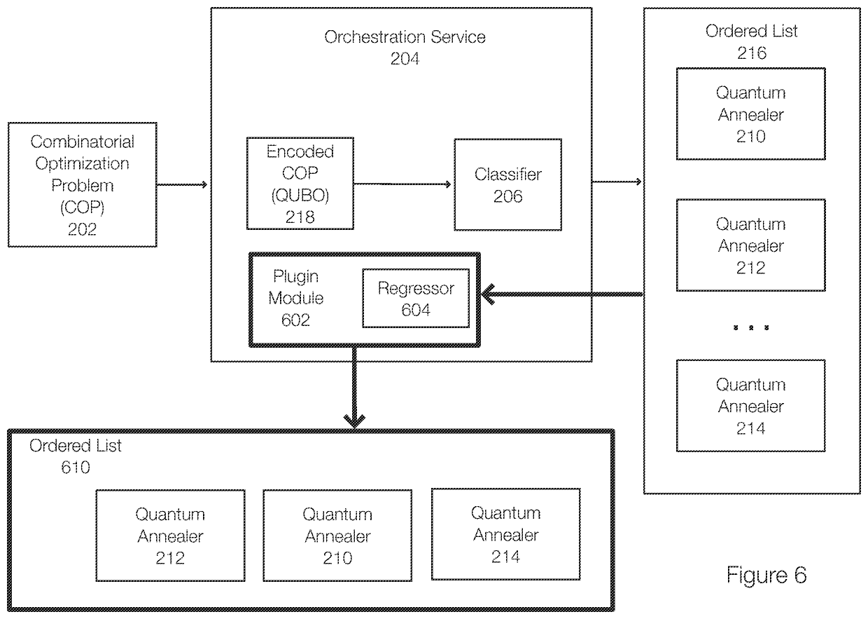

FIG. 6 discloses aspects of a modular orchestration service. FIG. 6 is similar to FIG. 2 and includes additional modules. In this example, the classifier 206 may output an ordered list 216 as previously described.

As illustrated in FIG. 6, the orchestration service 204 may also allow for modules to be added/removed. FIG. 6 illustrates that a plugin module 602 has been added to the orchestration service 204. The module 602 includes a regressor 604. In this example, the regressor 604 has been trained to estimate the computational time required for executing the combinatorial optimization problem 202 in the available quantum annealers. In one example, the combinatorial optimization problem 202 may be subject to service level objectives. The output of the regressor and/or the relevant service level objectives are examples of criteria that may influence the selection made by the orchestration service 204. As a result, even if the quantum annealer 210 is the most relevant quantum annealer output by the classifier 206, the module 206 may impact the order of the labels in the ordered list 216. Thus, the module 602 may generate an ordered list 610 that reorders the labels in the ordered list 216.

FIG. 6 illustrates, more generally, that multiple objectives or criteria may be evaluated before selecting a quantum annealer and submitting the combinatorial optimization problem 202 to the selected quantum annealer. Rather than reordering the list, an output of the module 602 may be used in selecting a label from the ordered list 216. Thus, the most relevant label (or quantum annealer) in the ordered list 216 may not be the first selection after considering additional criteria such as service level objectives and expected execution times. In another example, other modules may be added. A module may be configured, for example, to resolve conflicting criteria and conflicting goals. The modules can be activated/deactivated.

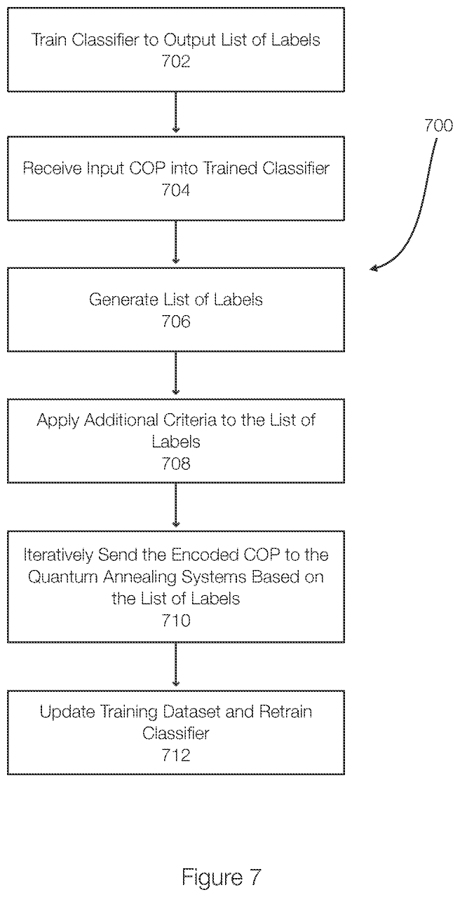

FIG. 7 discloses aspects of a method for selecting a quantum annealer in an automatic and informed manner. Aspects of the method 700 may be performed at different times and may be performed independently. The method 700, for example, illustrates both a training phase and an operational phase. Initially, a classifier is trained 702 to output a list of labels in a training phase that uses historical problem executions and characteristics of the quantum annealers used to solve those problems. Each of the labels corresponds to a quantum computing system, whether real or simulated.

During the operational phase, a combinatorial optimization problem is received 704 and input to the trained classifier (e.g., directly or after being encoded as a QUBO or other format). The format of the input to the trained classifier may vary, but may include features of the combinatorial optimization problem. The classifier then generates 706 a list of labels. Each of the labels identifies or corresponds to a quantum annealing system, whether real or simulated. This list of labels sorts the quantum annealing systems by relevance to the problem being considered.

If necessary or if desired, additional criteria is applied 708 to the list of labels. For example, other modules such as a service level objective module may be applied and which may impact the quantum annealing system initially selected to execute the input combinatorial optimization problem. Once the selection of a quantum annealer is confirmed, the combinatorial optimization problem (or the encoded combinatorial optimization problem such as a QUBO configuration) is sent to the selected annealing system. If necessary (e.g., execution at the selected quantum annealer fails), the orchestration service iterates 710 through the list of labels to select other quantum annealers to execute the combinatorial optimization problem until the problem is successfully executed or the list of labels is exhausted.

When execution is successful, the training dataset may be updated 712 and the classifier may be retrained at various times.

Embodiments of the invention thus relate to an automatic process that incorporates a classifier to generate a list of labels (or a list of quantum annealers) that are sorted by relevance according to the classifier output and with respect to the input problem. Features of combinatorial optimization problems may be extracted automatically into the training dataset. Once the ordered list of labels or quantum annealers is generated, the process of determining the best quantum annealing system may also use ad hoc information such as infrastructure availability when selecting a quantum annealing system to perform the quantum job.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods, processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, operations which may include, but are not limited to, quantum job operations, quantum job orchestration operations, quantum annealing system selection operations, machine learning model operations, sorting operations, operations, feasibility operations, compilation operations, QUBO execution related operations, or the like. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data functionality. Another example of a cloud computing environment is one in which processing, data protection, and other services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients or nodes that are capable of collecting, modifying, and creating, data. As such, a particular client or node may employ, or otherwise be associated with, one or more instances of each of one or more applications that perform such operations with respect to data. Such clients or nodes may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in any way.

Embodiment 1. A method comprising: receiving a problem to be solved at an orchestration service, inputting the problem to a classifier that is configured to generate an output that includes a list of labels, wherein each of the labels corresponds to a quantum computing system and wherein the labels are sorted according to relevance, wherein the classifier is trained using telemetry data of multiple quantum computing systems and features of solved historical problems, and sending the problem to a first quantum computing system associated with a first label, wherein the first label is a most relevant label in the list of labels.

Embodiment 2. The method of embodiment 1, wherein the quantum computing system comprises a quantum annealing system.

Embodiment 3. The method of embodiment 1 and/or 2, further comprising, when the first quantum computing system cannot solve the problem, sending the problem to a second quantum computing system associated with a second label, wherein the second label is a second most relevant label.

Embodiment 4. The method of embodiment 1, 2, and/or 3, further comprising iterating through quantum computing systems associated with the labels in the list of labels until the problem is solved or the list of labels is exhausted.

Embodiment 5. The method of embodiment 1, 2, 3, and/or 4, further comprising adding a module to the orchestration service, wherein the module is configured to consider additional criteria for selecting a quantum computing system, wherein the additional criteria impact an order of the labels in the list of labels.

Embodiment 6. The method of embodiment 1, 2, 3, 4, and/or 5, wherein the classifier comprises a chain classifier, further comprising encoding the problem as a quadratic unconstrained binary optimization configuration and inputting the encoded problem to the classifier.

Embodiment 7. The method of embodiment 1, 2, 3, 4, 5, and/or 6, further comprising adding the problem, once solved, and features of the solved problem to a training dataset.

Embodiment 8. The method of embodiment 1, 2, 3, 4, 5, 6, and/or 7, further comprising executing problems in a training data set at multiple quantum annealing systems, wherein features from each of the executions is added to a training dataset.

Embodiment 9. The method of embodiment 1, 2, 3, 4, 5, 6, 7, and/or 8, further comprising adjusting the list of labels based on service level objectives associated with the problem.

Embodiment 10. The method of embodiment 1, 2, 3, 4, 5, 6, 7, 8, and/or 9, further comprising generating an alert that the problem cannot be solved at a present time and attempting to solve the problem at a later time using the quantum computing systems associated with the labels in the list of labels.

Embodiment 11 A system, comprising hardware and/or software, operable to perform any of the operations, methods, or processes, or any portion of any of these, disclosed herein.

Embodiment 12 A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

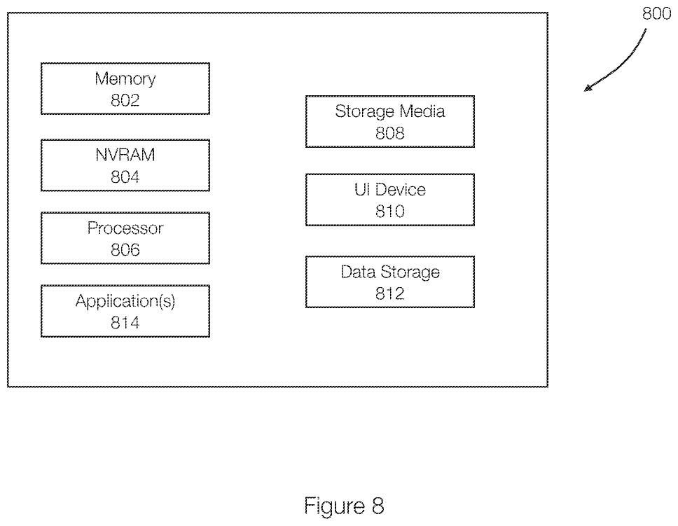

With reference briefly now to FIG. 8, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random-access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid-state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 800 is representative of classical computing systems, nodes, servers, clusters, virtual computers, or the like or combination thereof. The device 800 may also implement a virtual quantum system in a classical system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving a problem to be solved at an orchestration service;
inputting the problem to a classifier that is configured to generate an output that includes a list of labels, wherein each of the labels corresponds to a quantum computing system and wherein the labels are sorted according to relevance, wherein the classifier is trained using telemetry data of multiple quantum computing systems and features of solved historical problems; and
sending the problem to a first quantum computing system associated with a first label, wherein the first label is a most relevant label in the list of labels.

2. The method of claim 1, wherein the quantum computing system comprises a quantum annealing system.

3. The method of claim 2, further comprising, when the first quantum computing system cannot solve the problem, sending the problem to a second quantum computing system associated with a second label, wherein the second label is a second most relevant label.

4. The method of claim 1, further comprising iterating through quantum computing systems associated with the labels in the list of labels until the problem is solved or the list of labels is exhausted.

5. The method of claim 1, further comprising adding a module to the orchestration service, wherein the module is configured to consider additional criteria for selecting a quantum computing system, wherein the additional criteria impact an order of the labels in the list of labels.

6. The method of claim 1, wherein the classifier comprises a chain classifier, further comprising encoding the problem as a quadratic unconstrained binary optimization configuration and inputting the encoded problem to the classifier.

7. The method of claim 1, further comprising adding the problem, once solved, and features of the solved problem to a training dataset.

8. The method of claim 1, further comprising executing problems in a training data set at multiple quantum annealing systems, wherein features from each of the executions is added to a training dataset.

9. The method of claim 1, further comprising adjusting the list of labels based on service level objectives associated with the problem.

10. The method of claim 1, further comprising generating an alert that the problem cannot be solved at a present time and attempting to solve the problem at a later time using the quantum computing systems associated with the labels in the list of labels.

11. A non-transitory storage medium having stored therein instructions that are executable by one or more hardware processors to perform operations comprising:
receiving a problem to be solved at an orchestration service;
inputting the problem to a classifier that is configured to generate an output that includes a list of labels, wherein each of the labels corresponds to a quantum computing system and wherein the labels are sorted according to relevance, wherein the classifier is trained using telemetry data of multiple quantum computing systems and features of solved historical problems; and
sending the problem to a first quantum computing system associated with a first label, wherein the first label is a most relevant label in the list of labels.

12. The non-transitory storage medium of claim 11, wherein the quantum computing system comprises a quantum annealing system.

13. The non-transitory storage medium of claim 12, further comprising, when the first quantum computing system cannot solve the problem, sending the problem to a second quantum computing system associated with a second label, wherein the second label is a second most relevant label.

14. The non-transitory storage medium of claim 11, further comprising iterating through quantum computing systems associated with the labels in the list of labels until the problem is solved or the list of labels is exhausted.

15. The non-transitory storage medium of claim 11, further comprising adding a module to the orchestration service, wherein the module is configured to consider additional criteria for selecting a quantum computing system, wherein the additional criteria impact an order of the labels in the list of labels.

16. The non-transitory storage medium of claim 11, wherein the classifier comprises a chain classifier, further comprising encoding the problem as a quadratic unconstrained binary optimization configuration and inputting the encoded problem to the classifier.

17. The non-transitory storage medium of claim 11, further comprising adding the problem, once solved, and features of the solved problem to a training dataset.

18. The non-transitory storage medium of claim 11, further comprising executing problems in a training data set at multiple quantum annealing systems, wherein features from each of the executions is added to a training dataset.

19. The non-transitory storage medium of claim 11, further comprising adjusting the list of labels based on service level objectives associated with the problem.

20. The non-transitory storage medium of claim 11, further comprising generating an alert that the problem cannot be solved at a present time and attempting to solve the problem at a later time using the quantum computing systems associated with the labels in the list of labels.
